(19) United States
(12) Patent Application Publication
(10) Pub. No.: US 2017/0341121 A1
(43) Pub. Date: Nov. 30, 2017

(54) METHOD FOR PRODUCING A COMPONENT FROM DIFFERENT MATERIALS, AND COMPONENT AND USE THEREFOF

(71) Applicants: ThyssenKrupp Steel Europe AG, Duisburg (DE); ThyssenKrupp AG, Essen (DE)

(72) Inventors: Axel Köhler, Sprockhövel (DE); Janko Banik, Altena (DE); Sascha Sikora, Lünen (DE)

(73) Assignees: ThyssenKrupp Steel Europe AG, Duisburg (DE); ThyssenKrupp AG, Essen (DE)

(21) Appl. No.: 15/524,467

(22) PCT Filed: Oct. 26, 2015
(86) PCT No.: PCT/EP2015/074755

§ 371 Date: May 4, 2017

(30) Foreign Application Priority Data
Nov. 19, 2014 (DE) 10 2014 017 030.6

(51) Int. Cl. B21D 22/02; B21D 22/20; B29C 45/14; B21D 53/88; B62D 29/00; B29L 31/30

(52) U.S. Cl. CPC B21D 22/022; B21D 53/88; B62D 29/004; B21D 22/208; B29C 45/14221; C21D 2211/001; B29L 2031/3002

(57) ABSTRACT

A method may be used to produce a component that includes at least two different materials. The method may involve providing a hardenable planar or preformed steel sheet or steel profile, completely or partially heating the steel sheet or steel profile to the austenitic temperature, inserting the heated steel sheet or steel profile into a first tool for hot forming and/or press hardening the steel sheet or steel profile to give a completely or partially hardened steel workpiece. In the course of the hot forming and/or press hardening at least one jog is made in the steel sheet or the steel profile. The jog may serve for fastening at least one second material thereto.”

The invention relates to a method for producing a component including at least two different materials, which is characterized by the following method steps:

providing a hardenable planar or preformed steel sheet or steel profile,

completely or partially heating the steel sheet or steel profile to the austenitic temperature,

inserting the heated steel sheet or steel profile into a first tool for hot forming and/or press hardening the steel sheet or steel profile to give a completely or partially hardened steel workpiece, wherein in the course of the hot forming and/or press hardening at least one jog is made in the steel sheet or steel profile, which serves for fastening at least one second material thereto. Further, the invention relates to a correspondingly produced component and to a corresponding use of the component.

Generic components and methods for producing them are known in the prior art. For example, German published application 10 2011 109 010 discloses a component made from a hardened steel semi-finished product that is combined with a further flat part made of any desired material, and a corresponding production method. After heating it to austenitic temperature, there is made in the steel semi-finished product during the hot forming step a material projection that protrudes out of the plane of the steel semi-finished product and comprises a length corresponding to more than the material thickness of the further flat part that is to be fastened thereto. After hardening, the further flat part is provided with a corresponding opening and is laid on the steel semi-finished product to cover the material projection, wherein the material projection of the steel semi-finished product passes through the opening in the flat part. In a further step, the material projection is heated to a forming temperature, and in a final step the material projection is plastically and/or massively reworked onto the border of the opening of the flat part by suitable devices, to make a positively engaging connection.

The disadvantage of the prior art is that the hardened steel sheet has to be heated again at its material projection in order to enable further forming to result in positively engaging fastening thereto of a further material, wherein temperatures of in particular greater than 300° C. may be required which, depending on the second material to be fastened thereto, may damage the material, in particular if heat-sensitive materials are used. It is also possible for the microstructure of the hardened steel sheet to be impaired in the region of the connection, which in the case of its use as crash-relevant components in a vehicle may easily be a substantial disadvantage. Moreover, making a positively engaging connection in this way is very complex.

Taking this as a starting point, it is the object of the present invention to propose a method, a component and a use that obviate the above-mentioned disadvantages.

The stated object is achieved for a method in that there is provided as the second material a plastics material that is fastened to the steel workpiece for the purpose of at least partial reinforcement.

It has been found that a connection of different types of material, in particular in the case of hardened steel workpieces combined with plastics materials, for example with an adhesive connection, only a small force transmission is possible and weld connections, if weldable plastics materials are used, can impair the microstructure of the hardened steel workpiece as a result of a large quantity of heat being introduced at that location. According to the invention, a hardenable steel sheet is provided. This may take a planar shape or may alternatively already have been preformed cold, in particular comprising almost the final geometry, which among those skilled in the art is also known by the term of indirect or direct hot forming. The steel sheet or steel profile, which may take an enclosed form, is first partially or completely heated to austenitic temperature, wherein depending on the requirement made of the component to be produced and its intended use in the vehicle, (partially) different or entirely uniform microstructures may be set up in the steel material. This may be done using appropriate furnaces and/or appropriate forming/hardening dies. If different microstructures in the steel workpiece have to be taken into account, the term “tailored tempering” is used, that is to say that a hard microstructure and a softer microstructure, in particular one that is more ductile than the hard microstructure, are set up. At least, the steel workpiece is completely or partially hardened, which is achieved by quenching, in a tool that is in particular actively cooled, in the course of the hot forming and press hardening (direct hot forming) or in the course of the press hardening (indirect hot forming), wherein the microstructure of the at least austenitized region of the steel sheet is converted by rapid cooling into a martensitic and/or bainitic microstructure, wherein obtaining a martensitic microstructure is particularly preferred. At least one jog is made according to the invention in the course of the hot forming and/or press hardening, since the material is easy to work in the hot state. The jog, which may take a prong-like, tab-like, collar-like and/or ring-shaped form, serves to fasten on at least one second material. The method according to the invention further comprises providing plastics material as the second material, which is fastened to the completely or partially hardened steel workpiece at least for the purpose of partial reinforcement. The provision of plastics material, in addition to its low weight by comparison with metal materials, combines a suitably load-bearing construction with a partial increase in the strength, as a result of which the material thickness of the steel workpiece can be further reduced by comparison with a conventional application, which is quite capable of having a favorable effect on the overall weight of the vehicle. Preferably, fiber-reinforced plastics materials are used, in particular reinforced with glass, carbon and/or natural fibers, in particular plastics systems to which biologically degradable fibers have been added, and depending on the type of fiber this may influence the level of strength and rigidity of the plastics material, in particular also as a result of the proportion of filler content. In particular, natural fibers that are impregnated with biologically degradable plastics systems (plastic matrix) in combination with steel materials are entirely recyclable and are thus environmentally friendly. The plastics materials, or preferably fiber-reinforced plastics materials, that are used are heat-stable to at least 200° C., in particularly being resistant to cathodic EDP. Where fibers are taken into account, these are also heat-stable to at least 200° C., in particular being resistant to cathodic EDP.

According to a first embodiment of the method according to the invention, the jog is hardened. The jog is made in the course of hot forming by devices that are integrated in the tool and are matched to one another such that they extract heat rapidly once the jog is made and bring about hardening, as a result of which further deformation of the jog is no longer possible. As an alternative, the jog may not be hardened. This may be performed using the same devices that are integrated in the tool as for hardening, but with the difference that the devices extract substantially no heat from the jog, in particular if the devices for making the jog are made from a material with poor conductivity or are subject to temperature control or actively heated.

According to a further embodiment of the method according to the invention, the unhardened jog is made in the course of hot forming at an angle of preferably 90° to the plane of the steel workpiece. Once the steel workpiece has been hardened completely, with the exception of the jog or partially, a connection is made with a plastics material that is arranged at least partially in the region of the jog, wherein the jog is passed through the plastics material, which preferably comprises an opening or a slot at the appropriate location. The length of the jog is selected such that, once the two materials have been brought together, at least part of the jog projects out and in a further step is turned through 90° again to be parallel to, in particular making contact with, the plastics material for a positively engaging fastening thereto (cold). Preferably, the plastics material is already preformed and in particular fiber-reinforced, and corresponds to the geometry and dimensions, in particular being provided as a precisely fitting plastics molding, in order to be fastened to the steel workpiece and to make it at least partially stronger.

According to an alternative embodiment of the method according to the invention, the hardened jog is made in the course of the hot forming projecting at an angle of in particular less than 90°, preferably less than 60° and particularly preferably less than 45°, from the plane of the steel workpiece. Once the steel workpiece has been hardened completely or partially (with the jog), a connection is made with a plastics material, wherein the completely or partially hardened steel workpiece is inserted into a second tool, in particular an injection mold, and liquid plastics material is injected around and/or behind the steel workpiece, at least in the region of the jog. As a result of the preferably angled orientation (acute angle) of the jog, a type of undercut is provided which, in particular after curing of the plastics material, preferably of the fiber-reinforced plastics material, ensures that there is permanent fastening to the steel workpiece and makes it at least partially stronger.

According to a further aspect, the invention relates to a component including at least two different materials, which comprises a completely or partially hardened steel workpiece that comprises at least one jog by way of which at least one second material is fastened thereto, wherein the second material is made from a plastics material for the purpose of at least partially reinforcing the steel workpiece. In order to avoid repetition, the reader is referred to the statements above.

According to a further aspect, the invention relates to the use of an above-mentioned component as a crash-relevant component in a vehicle, in particular as an A, B, C or D pillar, a side member and/or a cross member. In order to avoid repetition, the reader is referred to the statements above.

The invention will be explained in more detail below with reference to a drawing that illustrates exemplary embodiments. Like parts are provided with like reference numerals. In the drawing:

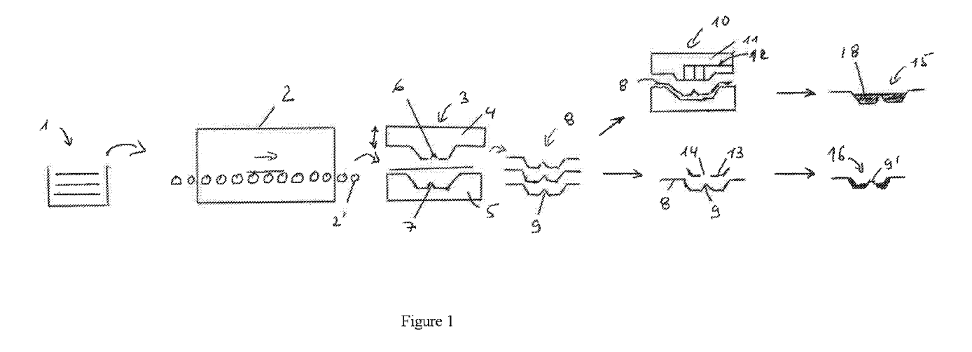

FIG. 1 shows an embodiment of a method according to the invention,

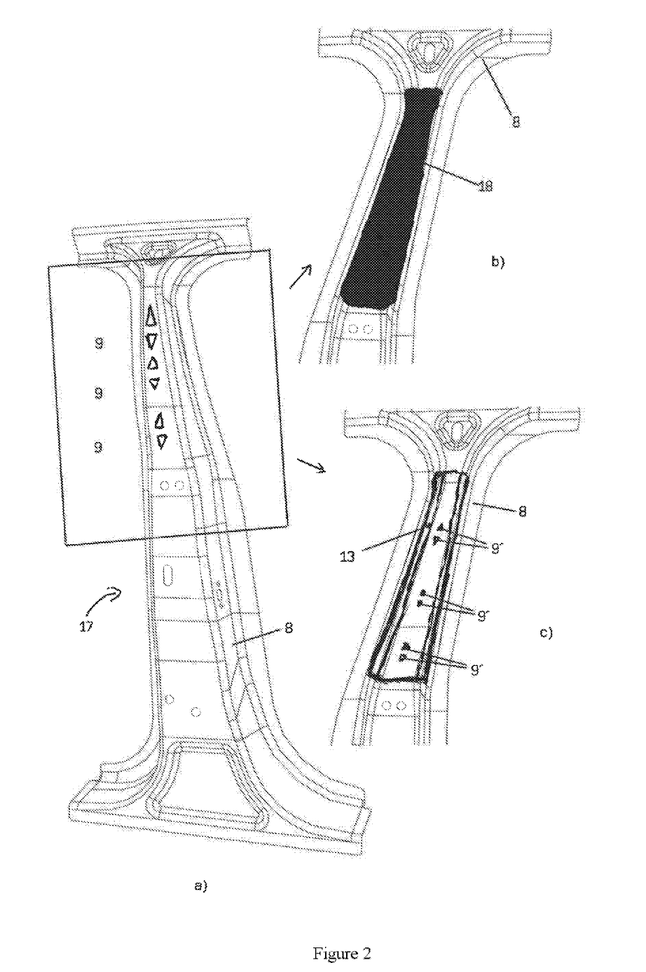

FIG. 2a shows a perspective illustration of an embodiment of a component according to the invention, in front view,

FIG. 2b shows a first embodiment of a partial region of the component shown in FIG. 2a, in rear view, and

FIG. 2c shows a second embodiment of a partial region of the component shown in FIG. 2a, in rear view.

FIG. 1 illustrates an embodiment, in particular a step-by-step sequence of a method according to the invention. Planar hardenable steel sheets 1 are provided. As an alternative, and not illustrated here, it is also possible to provide already preformed that may comprise almost the final geometry of the steel workpiece to be produced, or may take the form of closed steel profiles. The steel sheets 1 may also be cut from a coil to an appropriate length before they are provided and, if cutting is not part of the hot forming process, may be trimmed to the appropriate dimensions or as an alternative cut by hard laser cutting of the completely or partially hardened steel workpiece (not illustrated here in any of the drawings). In the next step, the steel sheet 1 is heated to austenitic temperature, for example in a roller hearth furnace 2. Other heating devices are also conceivably suitable but are not illustrated here. In the example shown, the steel sheet 1 is completely austenitized. As an alternative and not illustrated here, it is also possible to austenitize only partially a region of the steel sheet.

After the heating, and after it has exited from the roller hearth furnace 2, the steel sheet 1 is removed from the roller conveyor 2′ by way of suitable devices (symbolized here by an arrow) and transferred to a first tool 3, and inserted therein. The tool 3 includes an upper die 4 that takes the form of a punch and a lower die 5 that takes the form of a cavity. If necessary, and not illustrated here, it is also possible for hold-down devices to be provided. Provided in the cavity 5, at 7, is at least one projection or elevated portion, wherein there is provided on the opposite side, in the punch 4, at 6, at least one notch or recess. Once the austenitized steel sheet 1 has been inserted into the tool 3, the two die halves 4, 5 are brought together, typically with the lower die 5 being constructed to be stationary and the upper die 4 being movable in relation to the lower die 5, symbolized by the double-headed arrow that is illustrated perpendicular thereto. Bringing the die halves together has the effect first that the hot steel sheet is shaped by hot forming and, as a result of the typically active cooling by integrated cooling circuits (not illustrated here) within the die halves 4, 5, the still hot steel sheet is cooled, with the heat extraction rate being set such that, once the bottom position is reached, press hardening ensures that the austenitic microstructure is converted into a preferably martensitic microstructure. Before the bottom position is reached, at which point the hardening process is not yet complete and the steel sheet, which is still in the hot condition, is relatively easy to work, the projection 7 in the cavity 5, in conjunction with the notch 6 in the punch 4, makes at least one jog 9 in the steel workpiece 8 as a result of further relative movement between the die halves 4, 5. Depending on the application or fastening of the plastics material thereto, the jog 9 may be hardened, in which case the projection 7 and the notch 6 are cooled or heat is extracted from the jog 9 (not illustrated here), or the jog 9 is not hardened, in which case for example the projection 7 and the notch 6 are insulated or subject to temperature control (not illustrated here).

Depending on the component or the use thereof, it is possible to perform complete or partial hardening, wherein, in the case of partial hardening, the regions in the steel workpiece that are not to be converted to a completely martensitic microstructure are acted upon by heat, preferably during the hot forming and/or press hardening, by heating elements (not illustrated here) that are integrated in the tool.

If the jog 9 is made and hardened in the course of the hot forming and/or press hardening projecting at an angle of in particular less than 90°, preferably less than 60° and particularly preferably less than 45°, from the plane of the steel workpiece 8, wherein an unhardened jog 9 is also conceivable, then in a further step a plastics material is fastened on, wherein the completely or partially hardened steel workpiece 8 is inserted into a second tool, which is an injection mold 10 and in turn includes a lower mold and an upper mold 11, and liquid plastics material that is conveyed or injected through lines 12 within the upper mold 11 is injected around and/or behind the steel workpiece 8, at least in the region of the jog 9. The in particular angled orientation of the jog provides a type of undercut which, in particular after curing of the plastics material, preferably the fiber-reinforced plastics material, ensures a permanent fastening to the steel material and provides a component 15 that is at least partially stronger, wherein the cured plastics material 18 completely covers the jog.

As an alternative, a plastics material that has already been preformed and preferably takes the form of a fiber-reinforced, precisely fitting plastics molding 13 is provided in order to be fastened to the steel material 8 and to make it at least partially stronger. Fastening to the plastics molding 13, which is at least partially arranged in the region of the jog 9, is performed by devices that are not illustrated here, wherein the jog 9 is passed through the plastics molding 13, which preferably comprises an opening or a slot 14 at the appropriate location (fastening location). The length of the jog 9 is selected such that, once the two materials 16 have been brought together, at least part of the jog 9′ projects out and in a further step is turned through 90° again to be parallel to, in particular making contact with, the plastics molding 13 for a positively engaging fastening thereto (cold).

In FIGS. 2a to 2c, examples of a component in the form of a B pillar are shown, in particular produced by a first and a second method according to the invention. The hot forming and/or press hardening of planar or preformed steel sheets to give steel workpieces has already been sufficiently described.

In FIG. 2a, in a perspective illustration of a steel workpiece 8 in the form of a B pillar 17, jogs 9 are shown that are made in pairs as prongs in the form of isosceles triangles, wherein the tips of the triangles are oriented into the plane of the drawing (not visible). As an alternative, not illustrated here, the jogs may also take a tab-like, collar-like and/or ring-shaped form. The location of the reinforcement of a crash-relevant component may preferably be determined by simulation. Taking the example of the B pillar, the upper third of the component 17 is to be made stronger, as a result of which intrusion in the direction of the passenger compartment and, associated herewith, the risk of injury to the upper body/head of the vehicle occupants on the driver and passenger side in the event of a side impact can be reduced to a minimum. As regards the appearance of the geometry of the kink, it is particularly preferred if no geometric notching effect is produced. The geometry of the jog may also be determined in the course of a simulation.

FIG. 2b shows a partial region of FIG. 2a in rear view. The reinforcement by means of plastics material, preferably by means of fiber-reinforced plastics material, is performed in the course of injection molding behind and/or around the part, wherein the cured plastics material 18 completely covers the jogs (cf. FIG. 1, component 15).

As an alternative, in FIG. 2c, as a partial region of FIG. 2a, there is illustrated in rear view the fastening to a plastics molding 13, wherein the length of the jog 9, which was not hardened in the course of hot forming and/or press hardening, is dimensioned such that, after the two materials have been brought together, at least one projecting part of the jog 9′ is turned in a further step to be parallel to and in contact with the plastics molding 13 for a positively engaging fastening thereto (cf. FIG. 1, component 16).

The invention may be applied to any crash-relevant components and is not restricted to the exemplary embodiment.

### LIST OF REFERENCE NUMERALS

1 Steel sheet
2 Roller hearth furnace
2′ Roller conveyor
3 Tool
4 Upper die/punch
5 Lower die/die block
6 Notch/recess
7 Projection/elevated portion
8 Steel workpiece
9 Jog
9′ Projecting part of the jog
10 Injection mold
11 Upper mold
12 Lines
13 Plastics molding
14 Opening/slot
15 Component
16 Component
17 B pillar
18 Cured plastics material

1.-7. (canceled)

8. A method for producing a component that includes at least two different materials, the method comprising:
providing a hardenable planar or preformed steel sheet or steel profile;
at least partially heating the steel sheet or the steel profile to an austenitic temperature;
inserting the heated steel sheet or the heated steel profile into a first tool for at least one of hot forming or press hardening the steel sheet or the steel profile to produce a first steel workpiece that is at least partially hardened, wherein during the at least one of hot forming or press hardening a jog is made in the steel sheet or the steel profile, wherein the jog serves for fastening a second material to the first steel workpiece; and
fastening the second material to the first steel workpiece, wherein the second material comprises plastic and at least partially reinforces the first steel workpiece.

9. The method of claim 8 wherein the jog is hardened.

10. The method of claim 8 wherein the jog is not hardened.

11. The method of claim 8 further comprising:
passing the jog through the second material; and
turning a projecting part of the jog for a purpose of being received with positive engagement.

12. The method of claim 8 further comprising inserting the first steel workpiece into a second tool and injecting liquid plastic around and/or behind the first steel workpiece at least in a region of the jog.

13. The method of claim 12 wherein the second tool is an injection mold.

14. The method of claim 8 wherein a roller hearth furnace is used to at least partially heat the steel sheet or the steel profile.

15. The method of claim 8 wherein the steel sheet or the steel profile is completely austenitized.

16. The method of claim 8 wherein the first tool comprises a punch die.

17. A component including at least two different materials, the component comprising:
a steel workpiece that is at least partially hardened, the steel workpiece comprising a jog; and
a second material fastened to the steel workpiece by way of the jog, wherein the second material comprises plastic and at least partially reinforces the steel workpiece.

18. The component of claim 17 wherein the steel workpiece and the second material are configured as a crash-relevant component of a vehicle.

19. The component of claim 18 wherein the steel workpiece and the second material are configured as an A pillar, a B pillar, a C pillar, a D pillar, a side member, or a cross member of the vehicle.

20. The component of claim 17 wherein the steel workpiece and the second material are configured as an A pillar, a B pillar, a C pillar, a D pillar, a side member, or a cross member of a vehicle.
